(19) United States
(12) Patent Application Publication
(10) Pub. No.: US 2019/0169806 A1
(43) Pub. Date: Jun. 6, 2019

(54) APPARATUS FOR MARKING THE LOCATION OF A UTILITY FIXTURE

(71) Applicant: Tony Coursey, Reno, NV (US)

(72) Inventor: Tony Coursey, Reno, NV (US)

(21) Appl. No.: 16/205,052

(22) Filed: Nov. 29, 2018

Related U.S. Application Data
(60) Provisional application No. 62/593,676, filed on Dec. 1, 2017.

(51) Int. Cl. E01F 9/627; F16L 1/11; E01F 9/658; E01F 9/70

(52) U.S. Cl. CPC E01F 9/629; E01F 9/70; E01F 9/658; F16L 1/11

(57) ABSTRACT

A device for indicating a position within the ground of a utility fixture, such as on a construction site, includes a resilient body that is able to be secured around an open end of the utility fixture. The resilient body may be secured to the utility fixture using hose clamps. The resilient body supports a pole that extends upward of the resilient body and indicates the location of the utility fixture. When pressure is applied to the pole, such as if a vehicle inadvertently runs over the pole, the resilient body deflects to temporarily displace the pole horizontally. Once the pressure is removed, the resilient body returns the pole to the upward disposition. The resilient body also prevents the ingress of debris into the utility fixture.

### CROSS REFERENCE TO RELATED APPLICATIONS

This application claims priority to U.S. provisional patent application Ser. No. 62/593,676, filed 1 Dec. 2017, the contents of which is herein incorporated by reference.

### FIELD OF THE INVENTION

The present invention is generally related to the field of construction, and more particularly related to an apparatus for marking the location of a utility fixture wherein the apparatus may be run over by a construction related vehicle without causing permanent damage to a utility fixture, line or opening.

### BACKGROUND

In the field of construction, underground utility contractors spend countless hours and money repairing broken pipes that have been destroyed by heavy equipment. At a standard construction site, utility fixture pipes (such as sewer pipes, gas pipes, storm drains, electric conduits, or communications conduits) are marked by extending the pipe above ground for approximately one to five feet; this extended pipe portion is meant to mark the location of the utility fixture.

Using the extended pipe portion as an indicator of the location of utility fixtures present problems because the extended pipe portions are very often run over by a piece of heavy equipment such as a truck or a backhoe. When they are run over, the heavy equipment will crush the extended pipe portion and destroy a portion of pipe itself, usually forcing dirt and other debris into the broken-off utility pipe. When this commonplace event occurs, the utility contractor must both dig out the utility pipe and replace the pipe extension—a great expense of both time and resources.

There is a demonstrated need, therefore, for a device or apparatus that may mark the location of a utility fixture and that is not easily destroyed by heavy construction equipment.

### SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to mark a utility fixture;

the ability to protect a utility fixture during construction;

the ability to prevent ingress of dirt and debris into a utility fixture;

allow a utility fixture and marker to be run over without substantial damage to the utility fixture or marker;

the ability to visually indicate different types of utility fixtures.

These and other advantages may be realized by reference to the remaining portions of the specification, claims, and abstract.

### Brief Description of One Embodiment of the Present Invention

In one aspect, there is provided an apparatus for marking a location of a utility fixture. The apparatus may include a resilient tubular body and a first anchoring system that anchors the tubular body to the utility fixture. The tubular body may include a resilient circumferential side wall that forms the tubular body, a lower opening at a lower end of the side wall, and an upper opening at an upper end of the side wall. The lower opening may have a first external perimeter, the lower opening being dimensioned to fit over a utility fixture top. The upper opening may have a second external perimeter. A pole may be anchored within the upper opening and may extend upward of the tubular body. A second anchoring system may anchor the pole within the second opening of the tubular body. In use, the tubular body may be secured to the utility fixture such that the pole extends upward and thereby indicates the location of the utility fixture. The resilient tubular body may be able to bend in response to pressure applied to the pole to allow the pole to temporarily displace horizontally and return upward when the pressure to the pole is removed.

In one aspect, there is provided a method for indicating a position of a utility fixture within the ground. The method may comprise disposing a fixture indicating apparatus onto an open end of the fixture. The fixture indicating apparatus may comprise a resilient tubular body and a pole extending upward of the resilient tubular body. Disposing the fixture indicating apparatus may comprise disposing the tubular body on the utility fixture such that the pole extends upward and thereby indicates the location of the utility fixture. The resilient tubular body may be able to bend in response to pressure applied to the pole to allow the pole to temporarily displace horizontally and return upward when the pressure to the pole is removed.

In one aspect, there is provided apparatus for indicating a position of a utility fixture. The apparatus may comprise pole means for indicating a position and resilient body means for supporting the pole means and for anchoring to the utility fixture. The resilient body means may be able to bend in response to pressure applied to the pole means to allow the pole to temporarily displace horizontally and return upward when the pressure to the pole means is removed.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 illustrates a side view of a fixture indicating apparatus for marking the location of a utility fixture, in accordance with an exemplary embodiment of the present invention;

FIG. 2 illustrates a side view of a fixture indicating apparatus for marking the location of a utility fixture, in accordance with an alternative embodiment of the present invention having a magnet for removably attaching the apparatus to a utility fixture having a metal value box;

FIG. 3 illustrates a side view of a fixture indicating apparatus for marking the location of a utility fixture, in accordance with an alternative embodiment of the present invention having a flat rubber block for receiving a wood fixture;

FIG. 4A includes a photograph of an exemplary embodiment of the fixture indicating apparatus in use to mark the location of a utility fixture at a construction site;

FIG. 4B includes a photograph of an exemplary embodiment of the fixture indicating apparatus in use to mark the location of a utility fixture at a construction site, wherein heavy equipment has run over the fixture indicating apparatus (and the utility fixture beneath), the body has begun to flex, and the reflective pole has begun to displace towards a horizontal position to allow the heavy equipment to drive over the fixture indicating apparatus without permanently damaging the fixture indicating apparatus;

FIG. 4C includes a photograph of an exemplary embodiment of the fixture indicating apparatus in use to mark the location of a utility fixture at a construction site, wherein heavy equipment has run over the fixture indicating apparatus (and the utility fixture beneath), the body has begun to revert to its default upright position, and the reflective pole has begun to revert to its default vertical position; and

FIG. 4D includes a photograph of an exemplary embodiment of the fixture indicating apparatus in use to mark the location of a utility fixture at a construction site, wherein the body has reverted to its default upright position and the reflective pole has reverted to its default vertical position to continue to mark the location of the utility fixture.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention is generally related to the field of construction, and more particularly related to an apparatus for marking the location of a utility fixture wherein the apparatus may be run over by a construction related vehicle without causing permanent damage to a utility fixture, line or opening. The herein disclosed fixture indicating apparatus may be removably attached to a utility fixture so that an elongated member protrudes upward from the utility fixture to mark the location of the utility fixture and to indicate this location to observers or vehicles located nearby. While in use to indicate the location of the utility fixture, vehicles and other heavy equipment may then avoid running into or over the utility fixture. If nearby vehicles or other heavy equipment cannot avoid running into or over the utility fixture, the herein disclosed fixture indicating apparatus will flex (or bend) at the body and thus allow the reflective pole to displace to a horizontal position to avoid damage from the vehicle or heavy equipment passing above. A vehicle or piece of heavy equipment is then able to drive completely over the horizontally displaced reflective pole (and the rest of the sticker saver apparatus) without causing permanent damage to the reflective pole, the body, or the utility fixture beneath. Once the vehicle or heavy equipment is gone from the immediate area, the body reverts to its non-flexed position and thus raises the reflective pole back to its vertical default position so that the fixture indicating apparatus may continue to mark the location of the utility fixture.

An exemplary embodiment of the herein disclosed fixture indicating apparatus for marking the location of a utility fixture comprises: a resilient body with a bottom opening having a first external perimeter and an upper opening having a second external perimeter; the bottom opening being dimensioned to fit over a utility fixture top, wherein the bottom opening is anchored onto the utility fixture top by a first hose clamp secured about the first external perimeter; the upper opening for receiving a pole, wherein the pole is anchored within the upper opening by a second hose clamp secured about the second external perimeter; and wherein the pole indicates the location of the utility fixture to nearby observers and vehicles, and wherein the resilient body bends in response to pressure applied to the pole to allow the pole to temporarily displace horizontally and thus avoid permeant damage to the pole.

An alternative embodiment of the fixture indicating apparatus comprises a magnet for removably attaching the apparatus to a utility fixture having a metal valve box. A further alternative embodiment of the fixture indicating apparatus comprises a flat rubber block for receiving a wooden fixture and thus removably attaching the apparatus to the wooden fixture.

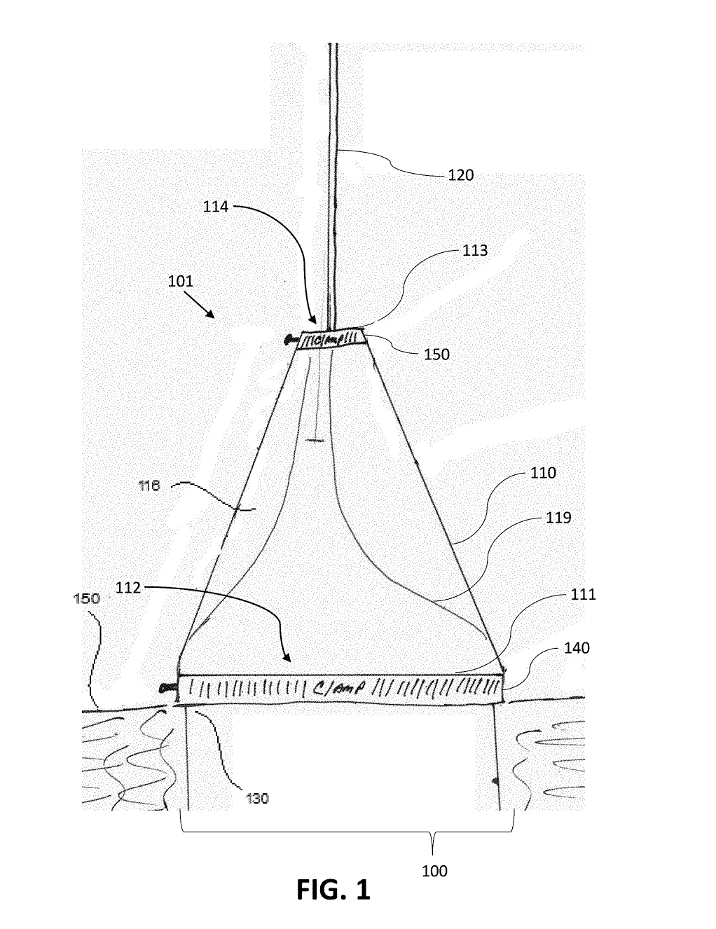

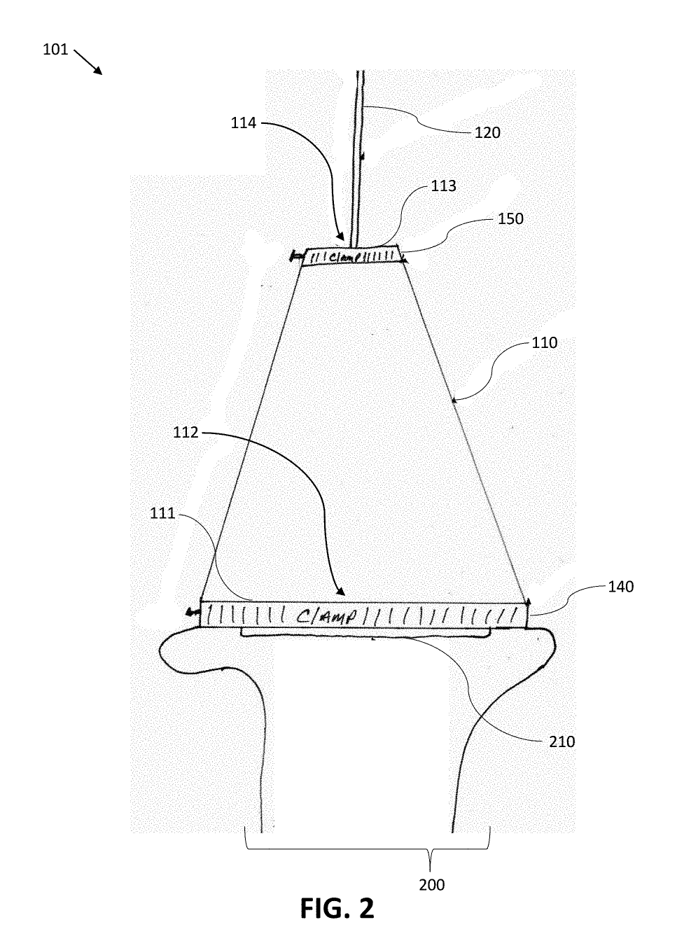

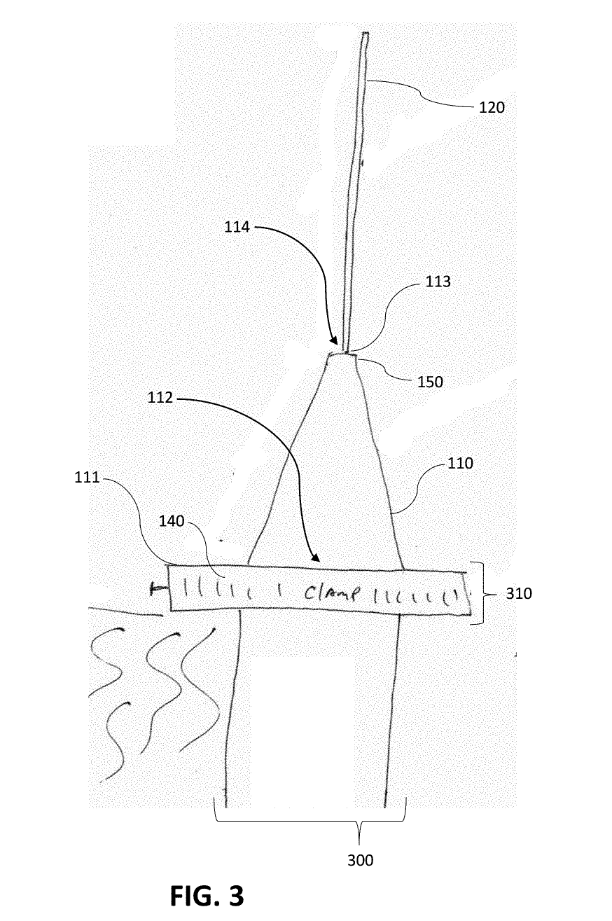

Referring to FIG. 1, herein disclosed fixture indicating apparatus 101 includes body 110 formed of a circumferential side wall 116 having bottom opening 112 and top opening 114. The body 110 is thus substantially tubular. Body 110 is formed of a flexible and resilient material, such as a flexible rubber for example, and will bend in response to pressure (or force) applied to body 110. Body 110 is described as being conical in shape in a preferred embodiment, but body 110 may be of any shape wherein body 110 forms bottom opening 112 having a first external perimeter 111 and forms upper opening 114 having a second external perimeter 113, and wherein first external perimeter 111 is greater than second external perimeter 113. Body 110 is shown primarily with a literal conical shape in FIG. 1, FIG. 2, and FIG. 3; an alternative profile shape for body 110 is shown by 119 in FIG. 1. In FIG. 1, the apparatus 101 is shown located over a utility fixture 100 that is substantially buried within the ground 150. The utility fixture 100 has a top 130 that protrudes slightly above the ground level 152. Body 110 is dimensioned to fit over utility fixture top 130. In a preferred embodiment of the present invention, body 110 has a height of approximately 8 inches.

Fixture indicating apparatus 101 is removably anchored to utility fixture top 130 by first hose clamp 140. Utility fixture 100 may be any type of utility fixture, such as a sewer pipe, a gas pipe, a storm drain, an electrical conduit, or a communications pipeline for example. Bottom opening 112 is dimensioned to fit over utility fixture top 130, and is secured or anchored to utility fixture top 130 by first hose clamp 140. Most utility pipes have a diameter of 4 inches to 12 inches, and in a preferred embodiment bottom opening 112 is dimensioned to fit over such a 4 to 12 inch diameter utility fixture pipe. First hose clamp 140 may be any type of hose clamp known in the art capable of securely (but removably) fastening body 110 to a round pipe such as the type normally found at utility fixture 100. Those skilled in the art will appreciate that other types of fasteners may be utilized to removably attach body 110 at utility fixture 100, and all such types of fasteners are intended to be included herein; for example, an adhesive may be utilized to removably attach body 110 at utility fixture top 130 or, alternatively, one or more screws may be utilized to removably attach body 110 at utility fixture top 130.

Body 110 forms upper opening 114 for receiving pole 120. Pole 120 may be any type of elongated member capable of rigidly (or semi-rigidly, as in the case of utilizing a bendably wire as the elongated member at 120) protruding upward from body 110. In a preferred embodiment, pole 120 has a height of approximately 6 feet, a diameter of approximately 1 inch, and has a reflective surface. The reflective surface is capable of reflecting vehicle headlights or other lights so that fixture indicating apparatus 101 is capable of indicating the location of utility fixture 100 at night or in the absence of ambient light. To further indicate the type of utility fixture 100 that fixture indicating apparatus 101 is marking, different color poles may be utilized at pole 120. For example, a green pole may indicate a sewer pipe at utility fixture 100, a yellow pole may indicate a gas pipe at utility fixture 100, a purple pole may indicate a storm drain at utility fixture 100, a red pole may indicate an electric conduit at utility fixture 100, and an orange pole may indicate a communications conduit at utility fixture 100.

Pole 120 is removably anchored within upper opening 114 by second hose clamp 150. Second hose clamp 150 may be any type of hose clamp known in the art capable of securely (but removably) fastening pole 120 within upper opening 114. Second hose clamp 150 has a smaller diameter than first hose clamp 140.

Referring to FIG. 2, a side view of fixture indicating apparatus 101 for marking the location of a utility fixture 200, in accordance with an alternative embodiment of the present invention having magnet 210 for removably attaching fixture indicating apparatus 101 to a utility fixture 200 having a metal valve box. Certain types of utility fixtures, such as water, sewer, or gas lines, may utilize a metal valve box at the exposed portion of the utility fixture; such a utility fixture is illustrated at 200. In this embodiment of the present invention, magnet 210 is attached to the underside of body 110, beneath bottom opening 112 and held in place by the clamp 140. Magnet 210 may be any type of magnet known in the art that is capable of securely and removably attaching fixture indicating apparatus 101 to utility fixture having a metal valve box 200. In this embodiment, instead of bottom opening 112 fitting over and around a protruding utility fixture pipe (as in the embodiment illustrated in FIG. 1), magnet 210 is placed on top of utility fixture having a metal valve box 200 to removably attach fixture indicating apparatus 101 to utility fixture having a metal valve box 200. In the embodiment illustrated in FIG. 2, second hose clamp 150 secures pole 120 within upper opening 114.

Referring to FIG. 3, a side view of fixture indicating apparatus 101 for marking the location of a utility fixture, in accordance with an alternative embodiment of the present invention having flat rubber block 310 for receiving wood fixture 300 is shown. In this alternative embodiment of the present invention, fixture indicating apparatus 101 may be removably attached (or anchored) to wood fixture 300. This embodiment is intended to facilitate attaching a fixture indicating apparatus 101 to a wooden fixture such as a wood beam or tie that may be forming a retaining wall, for example. Flat rubber block 310 may be attached to body 110 beneath bottom opening 112. Flat rubber block 310 may form a square or rectangular opening for receiving wood fixture 300. In this way, flat rubber block 310 may removably attach (or anchor) over a protruding wood beam or tie to anchor fixture indicating apparatus 101 to wood fixture 300. Flat rubber block 310 may be formed of materials other than rubber.

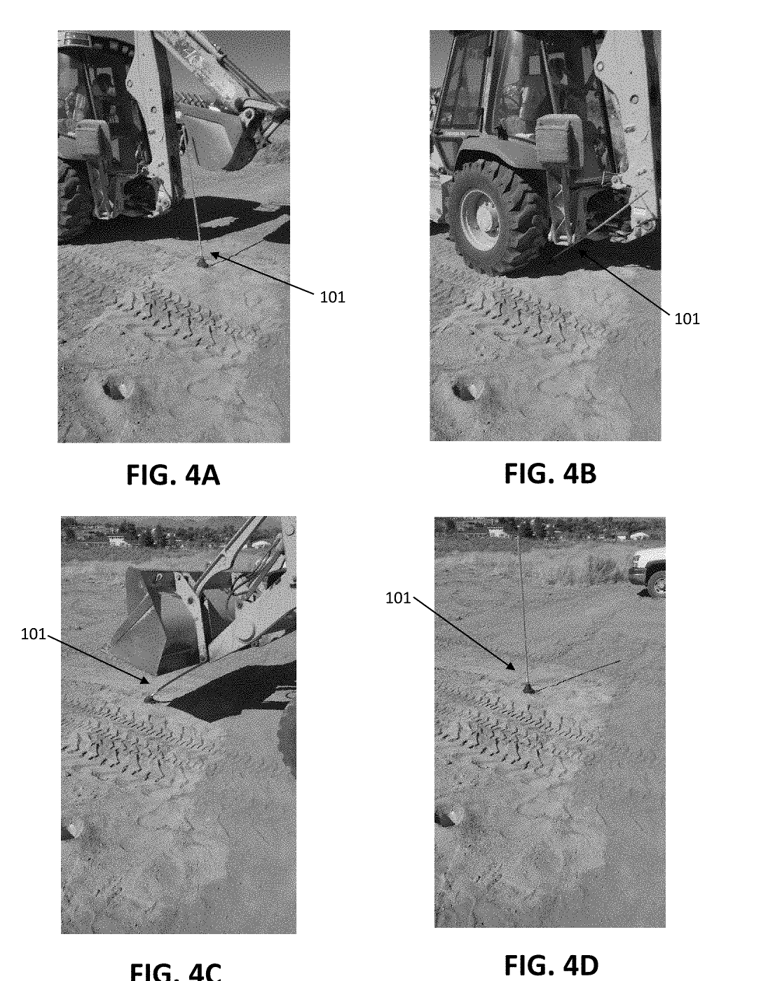

Referring to FIG. 4A, FIG. 4B, FIG. 4C, and FIG. 4D, a herein disclosed fixture indicating apparatus 101 is shown in use to mark a utility fixture while the fixture indicating apparatus 101 is driven over by a piece of heavy equipment. As discussed herein, the purpose of fixture indicating apparatus 101 is to mark the location of a utility fixture so that vehicles and heavy equipment may avoid running over the utility fixture and damaging the protruding pipe or conduit (referred to in the construction field as a “sticker”). FIG. 4A shows fixture indicating apparatus 101 in its default vertical (or upright) position to mark the location of a utility fixture in a way that is highly visible to vehicles and other heavy equipment. FIG. 4B shows a piece of heavy equipment failing to notice fixture indicating apparatus 101, and therefore driving the heavy equipment over fixture indicating apparatus 101. As can be seen in FIG. 4B, when this happens the heavy equipment applies pressure (or force) against the protruding reflective pole, thereby flexing the body of fixture indicating apparatus 101, which in turn displaces the reflective pole down to a horizontal position (FIG. 4B shows the reflective pole as it is being displaced towards the horizontal position). When the reflective pole is in a horizontal position, the piece of heavy equipment is able to drive over fixture indicating apparatus 101 without causing damage to either fixture indicating apparatus 101 or the utility fixture. After the vehicle or heavy equipment has driven past fixture indicating apparatus 101, the body will return to its default non-flexed position due to the resilient nature of the material used to form the body, thus forcing the reflective pole back up to its default vertical position. FIG. 4C then shows the reflective pole on its way back up to its default vertical position. And FIG. 4D shows fixture indicating apparatus 101 in its fully vertical position after the piece of heavy equipment has completely driven over fixture indicating apparatus 101. In this way, fixture indicating apparatus 101 may continue to mark the location of the utility fixture even after being hit or driven over.

It has thus been demonstrated that the present invention provides an apparatus that can both indicate the location of utility fixtures and avoid permanent damage in the case of being hit or run over by heavy construction equipment. An advantage of the fixture indicating apparatus is that in some embodiments, the fixture indicating apparatus may allow the end of the fixture to be disposed below the ground level but prevent the ingress of dirt and debris into the fixture opening. In these embodiments, the fixture is protected even where the wheels of the vehicle run directly over the fixture. In alternative embodiments, the end of the fixture may be disposed above ground level where it may be at risk of being run over by vehicles etc. However, because of the length of the elongate member, the driver of a vehicle is able to maintain awareness of the location of the fixture even where the actual fixture has disappeared out of the view of the driver as the fixture moves under the vehicle.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. An apparatus for marking a location of a utility fixture comprising:
(A) a resilient tubular body comprising:
(a) a resilient circumferential side wall that forms the tubular body;
(b) a lower opening at a lower end of the side wall, the lower opening having a first external perimeter, the lower opening being dimensioned to fit over a utility fixture top; and
(c) an upper opening at an upper end of the side wall, the upper opening having a second external perimeter;
(B) a first anchoring system that anchors the tubular body to the utility fixture;
(C) a pole anchored within the upper opening that extends upward of the tubular body; and
(D) a second anchoring system that anchors the pole within the second opening of the tubular body;
(E) wherein, in use, the tubular body may be secured to the utility fixture such that the pole extends upward and thereby indicates the location of the utility fixture, and wherein the resilient tubular body is able to bend in response to pressure applied to the pole to allow the pole to temporarily displace horizontally and return upward when the pressure to the pole is removed.

2. The apparatus of claim 1 wherein the tubular body is configured to cover an open end of the utility fixture and prevent ingress of material into the utility fixture.

3. The apparatus of claim 1 wherein the tubular body is anchored to the utility fixture by a first hose clamp secured about the first external perimeter.

4. The apparatus of claim 3 wherein the pole is anchored within the upper opening of the tubular body by a second hose clamp secured around the second external perimeter.

5. The apparatus of claim 1 comprising a magnet secured within the lower opening for removably attaching the apparatus to the utility fixture.

6. The apparatus of claim 1 comprising a block received in the lower opening, the block comprising an opening for receiving an end of a wooden fixture.

7. The apparatus of claim 1 wherein the tubular body is conical.

8. A method for indicating a position of a utility fixture within the ground, the method comprising:
(A) disposing a fixture indicating apparatus onto an open end of the fixture, the fixture indicating apparatus comprising:
(a) a resilient tubular body; and
(b) a pole extending upward of the resilient tubular body;
(B) wherein disposing the fixture indicating apparatus comprises disposing the tubular body on the utility fixture such that the pole extends upward and thereby indicates the location of the utility fixture, wherein the resilient tubular body is able to bend in response to pressure applied to the pole to allow the pole to temporarily displace horizontally and return upward when the pressure to the pole is removed.

9. The method of claim 8 wherein the tubular body comprises a lower opening, wherein disposing the tubular body onto the utility fixture comprises securing the lower opening around the utility fixture.

10. The method of claim 9 comprising securing the tubular body about the utility fixture using a hose clamp.

11. The method of claim 9 wherein the tubular body seals an open end of the utility fixture to prevent the ingress of debris into the utility fixture.

12. The method of claim 8 comprising securing a magnet within a lower end of the tubular body and magnetically securing the tubular body to the utility fixture.

13. Apparatus for indicating a position of a utility fixture comprising:
(A) pole means for indicating a position;
(B) resilient body means for supporting the pole means and for anchoring to the utility fixture,
(C) wherein the resilient body means is able to bend in response to pressure applied to the pole means to allow the pole means to temporarily displace horizontally and return upward when the pressure to the pole means is removed.

14. The apparatus of claim 13 comprising first anchor means for anchoring a lower end of the resilient body means about the utility fixture.

15. The apparatus of claim 14 wherein the first anchor means comprises hose clamp means.

16. The apparatus of claim 13 comprising magnet means for magnetically anchoring the resilient body means to the utility fixture.

17. The apparatus of claim 13 wherein the resilient body means provides sealing mean for sealing an open end of the utility fixture to prevent the ingress of debris into the utility fixture.
